(19) United States
(12) Patent Application Publication
(10) Pub. No.: US 2022/0026289 A1
(43) Pub. Date: Jan. 27, 2022

(54) PROJECTIVE CAPACITIVE FORCE SENSING STRUCTURE

(71) Applicant: UNEO INCORPORATED, Taipei (TW)

(72) Inventors: Yann-Cherng Chern, New Taipei (TW); Chih-Sheng Hou, Taipei (TW)

(21) Appl. No.: 17/381,475

(22) Filed: Jul. 21, 2021

Related U.S. Application Data
(60) Provisional application No. 63/055,693, filed on Jul. 23, 2020.

(51) Int. Cl. G01L 1/14

(52) U.S. Cl. CPC G01L 1/142

(57) ABSTRACT

A projective capacitive force sensing structure is provided. The projective capacitive force sensing structure includes a first substrate, a first electrode, a first capacitance material layer, a second substrate, a second electrode and a third electrode. The stacking order of the projective capacitive force sensing structure is from the first substrate to the second substrate. The second electrode and the third are respectively below and above the second substrate. A first signal is detected between the first electrode and the second electrode and is collected by the first electrode. A second signal is detected between the second electrode and the third electrode and is collected by the third electrode. A force applied by an object is determined according to the first signal and a location of the object is determined according to the second signal. Both the force applied by an object and the location of the object are acquired.

### CROSS-REFFERENCE TO RELATED APPLICATION

This application claims priority from the U.S.A Provisional Application No. 63/055,693, filed on Jul. 23, 2020 in USPTO, the disclosures of which are hereby incorporated by reference in their entirety for all purposes.

### BACKGROUND OF THE INVENTION

### Field of the Invention

The present invention relates to the technical field of sensors, and particularly to a projective capacitive force sensing structure.

### Description of the Related Art

Recently, touch sensor is used in many applications, such as touch panels and mobile devices. In mobile devices, the touch sensor is disposed on the screen and has the ability to detect where the finger touches. However, when the hand touches multiple touching points on the screen, the touch sensor would have the problem of the ghost point.

Accordingly, the inventor of the present invention has designed a projective capacitive force sensing structure to overcome deficiencies in terms of current techniques so as to enhance the implementation and application in industries.

### SUMMARY OF THE INVENTION

In view of the aforementioned issues, the purpose of the present invention is to provide the projective capacitive force sensing structure to solve the problems found in the conventional techniques.

In order to achieve the objective, the present invention provides the projective capacitive force sensing structure. The projective capacitive force sensing structure includes a first substrate, a first electrode, a first capacitance material layer, a second substrate, a second electrode and a third electrode. The first electrode is disposed on the first substrate. The first capacitance material layer is disposed on the first electrode. The second substrate is disposed above the first substrate and is provided with a first surface and a second surface opposite to the first surface. The first surface faces the first substrate. The second electrode is disposed on the first surface, the second electrode overlaps the first electrode, and a first signal detected between the first electrode and the second electrode is collected by the first electrode. The third electrode is disposed on the first surface or the second surface, and a second signal detected between the second electrode and the third electrode is collected by the third electrode. A force applied by an object is determined according to the first signal and a location of the object is determined according to the second signal.

Optionally, the first capacitance material layer is made of piezo-capacitive material, and a quantifiable electrical parameter between the first electrode and the second electrode increases when applying force to the second electrode.

Optionally, the first signal is increased when the force applied to the first capacitance material layer is increased.

Optionally, the values of the first signal and the value of second signal vary in opposite direction.

Optionally, the projective capacitive force sensing structure comprises a second capacitance material layer disposed on the second electrode and an air gap located between the first capacitance material layer and the second capacitance material layer.

Optionally, the second electrode connects to a first transmitting terminal, the first electrode connects to a first receiving terminal and the third electrode connects to a second receiving terminal.

Optionally, the first signal is detected by mutual capacitive detection between the first electrode and the second electrode, and a capacitive interference of the second signal is blocked by the second electrode.

Optionally, the second signal is detected by mutual capacitive detection between the second electrode and the third electrode, and a capacitive interference of the first signal is blocked by the second electrode.

Optionally, the first electrode is arranged in a first direction and the second electrode is arranged in a second direction, and the first direction intersects with the second direction.

Optionally, the third electrode is arranged in the first direction.

Optionally, the projective capacitive force sensing structure comprises a support plate and a cover layer, the first substrate is disposed on a support plate and the second substrate is disposed on the cover layer.

Optionally, the support plate comprises a shielding layer, and the shielding layer is disposed opposite to the first substrate.

Optionally, the projective capacitive force sensing structure comprises an adhesive layer, and the adhesive layer is disposed between the support plate and the first substrate and between the cover layer and the second electrode.

Optionally, the projective capacitive force sensing structure comprises a spacer, and the spacer is disposed between the first substrate and the second substrate.

In accordance with the above description, the projective capacitive force sensing structure is able to acquire the force applied by the object and the location of the object. By the configuration of the present invention, the problem of the ghost point could be prevented.

### BRIEF DESCRIPTION OF THE DRAWINGS

FIG. 1 is a structural diagram of the first embodiment of the projective capacitive force sensing structure of the present invention.

FIG. 2 is a structural diagram of the second embodiment of the projective capacitive force sensing structure of the present invention.

FIG. 3A is a schematic diagram of the projective capacitive force sensing structure of the present invention during no-touching period.

FIG. 3B is a schematic diagram of the projective capacitive force sensing structure of the present invention during sensing period.

FIG. 4 is a structural diagram of the third embodiment of the projective capacitive force sensing structure of the present invention.

FIG. 5 is a structural diagram of the fourth embodiment of the projective capacitive force sensing structure of the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. It is to be acknowledged that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

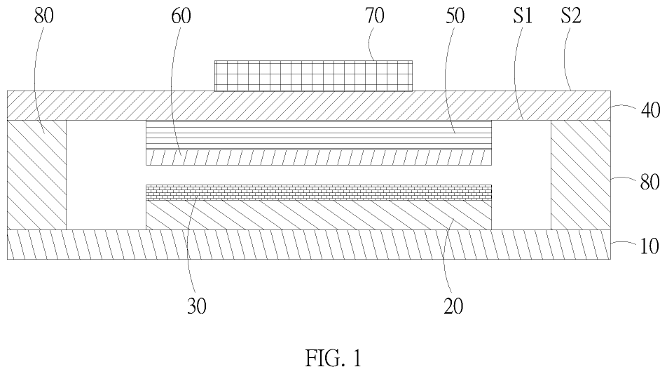

Please refer to FIG. 1, which is a structural diagram of the first embodiment of the projective capacitive force sensing structure of the present invention. As shown by FIG. 1, the projective capacitive force sensing structure includes a first substrate 10, a first electrode 20, a first capacitance material layer 30, a second substrate 40, a second electrode 50 and a third electrode 70. The first electrode 20 is disposed on the first substrate 10. The first capacitance material layer 30 is disposed on the first electrode 20. The second substrate 40 is disposed above the first substrate 10 and is provided with a first surface 51 and a second surface S2 opposite to the first surface S1. The first surface S1 faces the first substrate 10. The second electrode 50 is disposed on the first surface S1, and the second electrode 50 overlaps the first electrode 20. A first signal is detected between the first electrode 20 and the second electrode 50 and is collected by the first electrode 20. A third electrode 70 is disposed on the second surface S2. A second signal is detected between the second electrode 50 and the third electrode 70 and is collected by the third electrode 70. A force applied by an object is determined according to the first signal and a location of the object is determined according to the second signal. By this configuration, both the force applied by an object and the location of the object are acquired.

In the first embodiment, the first surface S1 is on the side adjacent to the second electrode 50 and the second surface S2 is on the side far from the second electrode 50. The first surface S1 and the second surface S2 are opposite. The second electrode 50 is on the first surface S1 and the third electrode 70 is on the second surface S2. Namely, the second electrode 50 and the third electrode 70 are on opposite surfaces of the second substrate 40.

The projective capacitive force sensing structure further includes the second capacitance material layer 60 and two spacers 80. The second capacitance material layer 60 is disposed on the second electrode 50. Two spacers 80 are between the first substrate 10 and the second substrate 40. One spacer 80 is on the one side of the first substrate 10, and the other spacer 80 is on the other side of the first substrate 10.

In one embodiment, there is an air gap between the first capacitance material layer 30 and the second capacitance material layer 60. In the another embodiment, the first capacitance material layer 30 and the second capacitance material layer 60 contacts the second capacitance material layer 60 without an air gap therebetween.

Wherein, the first substrate 10 and the second substrate 40 may include a glass substrate, quartz substrate, ZnO substrate, sapphire substrate, GaN substrate or SiC substrate, but are not limited thereto. The material of the first electrode 20, the second electrode 50 and the third electrode 70 may include indium (In), tin (Sn), aluminum (Al), gold (Au), platinum (Pt), zinc (Zn), germanium (Ge), silver (Ag), lead (Pb), palladium (Pd), copper (Cu), AuBe, BeGe, nickel (Ni), PbSn, chromium (Cr), AuZn, titanium (Ti), tungsten (W), TiW, or any combination thereof, but are not limited thereto. The material of the first capacitance material layer 30 and the second capacitance material layer 60 may include piezo-capacitive material, such as BaTiO₃, PbTiO₃, Pb(ZrTi)O₃(Lead zirconate titanate 'PZT) and GaN, but are not limited thereto.

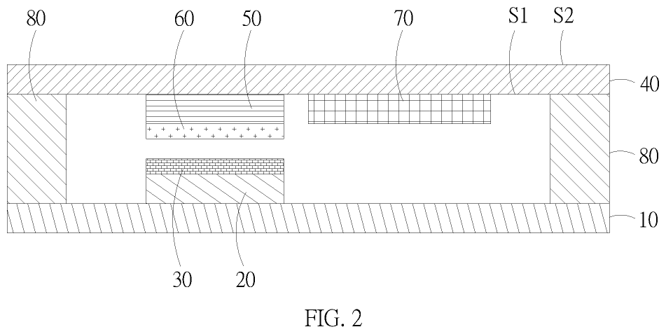

Please refer to FIG. 2, which is a structural diagram of the second embodiment of the projective capacitive force sensing structure of the present invention. As shown by FIG. 2, the projective capacitive force sensing structure includes the first substrate 10, the first electrode 20, the first capacitance material layer 30, the second substrate 40, the second electrode 50, the second capacitance material layer 60, the third electrode 70 and two spacers 80, and the similarity between the second embodiment and the first embodiment is not repeated here. However, there is a difference between the second embodiment and the first embodiment: the third electrode 70 is disposed on the first surface S1. Namely, the second electrode 50 and the third electrode 70 are on the same surface of the second substrate 40.

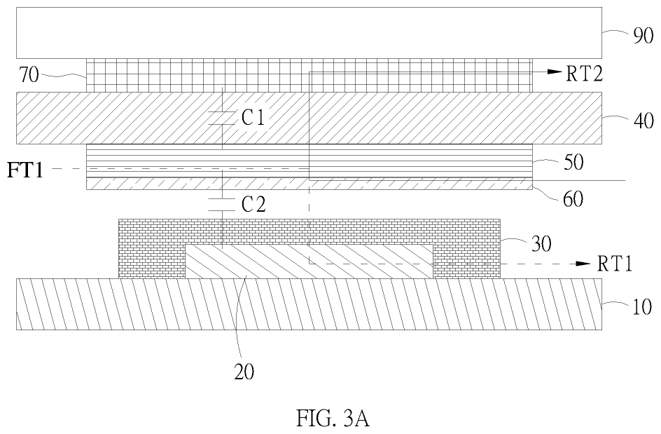

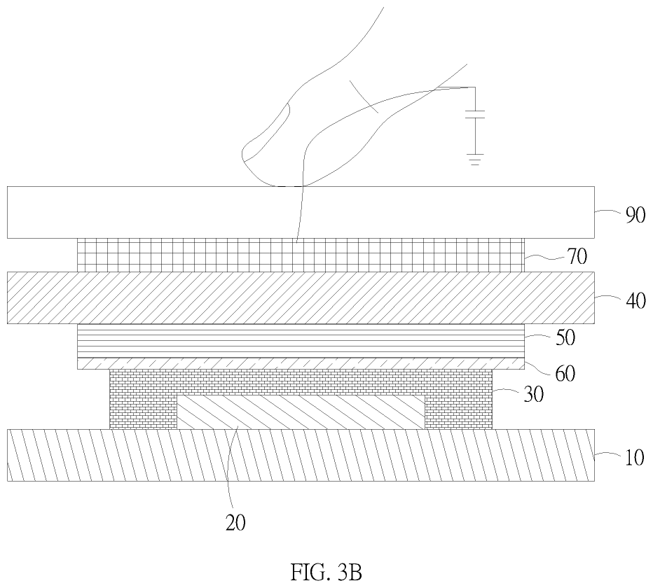

Please refer to FIG. 3A, which is a schematic diagram of the projective capacitive force sensing structure of the present invention during no-touching period. It is needed to be mentioned that the second electrode 50 connects to the first transmitting terminal FT1 and acts as a transmitter, the first electrode 20 connects to the first receiving terminal RT1 and acts as a receiver, and the third electrode 70 connects to the second receiving terminal RT2 and acts as a receiver. There is a cover layer 90 disposed on the third electrode 70. As shown by FIG. 3A, the second electrode 50 receives one current from the first transmitting terminal FT1, and the current would be outputted to the second receiving terminal RT2 through the third electrode 70 and would be outputted to the first receiving terminal RT1 through the first electrode 20. There is a first mutual capacitance C1 due to the interaction between the second electrode 50 and the third electrode 70. There is a second mutual capacitance C2 due to the interaction between the second electrode 50 and the first electrode 20.

Please refer to FIG. 3B, which is a schematic diagram of the projective capacitive force sensing structure of the present invention during sensing period. As shown by FIG. 3B, when the finger of the user touches the cover layer 90, the first capacitance material layer 30 contacts the second capacitance material layer 60 and there is no air gap therebetween. The interaction between the second electrode 50 and the third electrode 70 and the interaction between the second electrode 50 and the first electrode 20 would be changed. The value of the first mutual capacitance C1 and the second mutual capacitance C2 would be changed. When the value of the first mutual capacitance C1 and the second mutual capacitance C2 are changed, the first signal and the second signal would be generated. The set of the first electrode 20 and the second electrode 50 measures the force applied by the finger of the user. The value of the force applied by the finger of the user is determined based on the first signal. The set of the second electrode 50 and the third electrode 70 measures the location where the finger of the user touches. The location where the finger of the user touches is determined based on the second signal. The first signal is detected by mutual capacitive detection between the first electrode 20 and the second electrode 50, and a capacitive interference of the second signal is blocked by the second electrode 50. The second signal is detected by mutual capacitive detection between the second electrode 50 and the third electrode 70 and a capacitive interference of the first signal is blocked by the second electrode 50. That is, the second electrode 50 acts as a shield layer in the projective capacitive force sensing structure of the present invention.

Because the first capacitance material layer 30 and the second capacitance material layer 60 are made of piezo-capacitive material, the interface between the first capacitance material layer 30 and the first electrode 20 and the interface between the second electrode 50 and the second capacitance material layer 60 would have positive charges and negative charges when applying force to the second electrode 50, positive charges and negative charges would be helpful to enhance the electric filed between the first electrode 20 and the second electrode 50. The electric field is the interaction between the second electrode 50 and the first electrode 20. When the electric field is enhanced, the value of the second mutual capacitance C2(i.e. quantifiable electrical parameter) would be increased.

When the force applied to the cover layer 90 and the first capacitance material layer 30 is increased, the first signal would be increased and the second signal would be decreased because the finger of the user disturbs the electrical field propagation between the second electrode 50 and the third electrode 70. Namely, the value of the first signal and the value of the second signal vary in opposite direction.

Besides, the first transmitting terminal FT1, the first receiving terminal RT1 and the second receiving terminal RT2 would be electrically connected to the electronic device with the processor. The electronic device with the processor would determine the location where the finger of the user touches and the value of the force applied by the finger of the user according to the first signal and the second signal. The electronic device having the processor would be the computer or the laptop, but is not limited thereto.

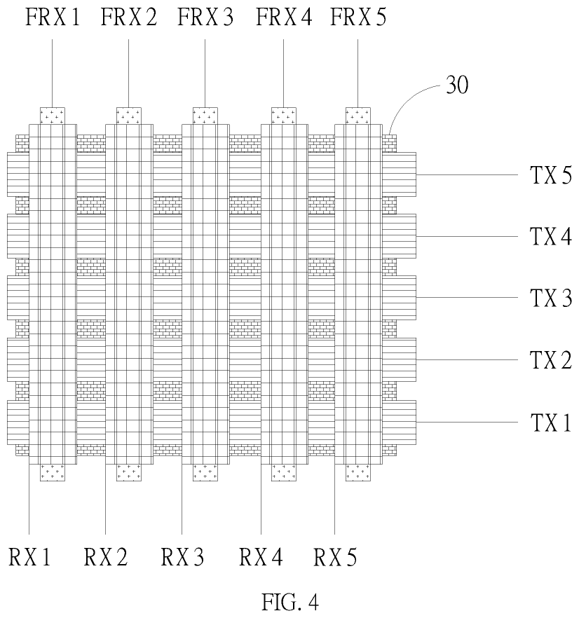

Please refer to FIG. 4, which is a structural diagram of the third embodiment of the projective capacitive force sensing structure of the present invention. As shown by FIG. 4, the projective capacitive force sensing structure includes the first substrate 10, the first electrode FRX1˜FRX5, the first capacitance material layer 30, the second substrate 40, the second electrode TX1˜TX5, the second capacitance material layer 60, the third electrode RX1˜RX5 and two spacers 80, and the similarity between the third embodiment and the first embodiment is not repeated here. However, there is a difference between the third embodiment and the first embodiment: there are a plenty of first electrodes FRX1˜FRX5, a plenty of second electrodes TX1˜TX5 and a plenty of third electrodes RX1˜RX5. The shape of each first electrode FRX1˜FRX5, each second electrode TX1˜TX5 and each third electrode RX1˜RX5 is the stripe. The first electrodes FRX1˜FRX5 and the third electrodes RX1˜RX5 are arranged in the first direction D1. The second electrodes TX1˜TX5 are arranged in the second direction D2. The first direction D1 intersects with the second direction. The plurality of first electrodes FRX1˜FRX5, the plurality of second electrodes TX1˜TX5 and the plurality of third electrodes RX1˜RX5 constitute a matrix. Each first electrode FRX1˜FRX5 and each second electrode TX1˜TX5 intersect at a first intersection point serving as a force measuring point for measuring the force applied by an object(e.g. the finger of the user). Each third electrode RX1˜RX5 and each second electrode TX1˜TX5 intersect at a second intersection point serving as a location detecting point for detecting the location of the object(e.g. the finger of the user).

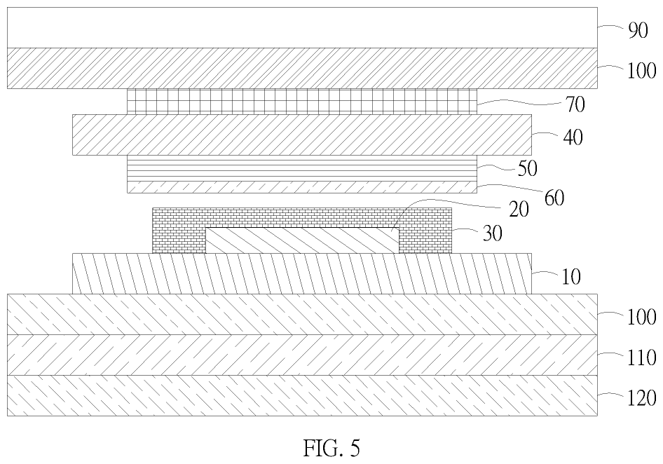

Please refer to FIG. 5, which is a structural diagram of the fourth embodiment of the projective capacitive force sensing structure of the present invention. As shown by FIG. 5, the projective capacitive force sensing structure includes the first substrate 10, the first electrode 20, the first capacitance material layer 30, the second substrate 40, the second electrode 50, the second capacitance material layer 60, the third electrode 70 and two spacers 80 and the similarity between the second embodiment and the first embodiment is not repeated here. However, there is a difference between the fourth embodiment and the first embodiment: the present invention further includes the cover layer 90, the adhesive layer 100, the support plate 110 and the shield layer 120. The shielding layer 120 is disposed opposite to the first substrate 10. The support plate 110 is disposed on the shield layer 120, and the adhesive layer 100 is disposed on the support plate 110. The first substrate 10 is disposed on the adhesive layer 100. The adhesive layer 100 is disposed between the support plate 110 and the first substrate 10.

The cover layer 90 is disposed on the second substrate 40. The adhesive layer 100 is disposed on the second substrate 40. The adhesive layer 100 is disposed between the cover layer 90 and the second electrode 50. Namely, the adhesive layer 100 is disposed on the third electrode 70 and the adhesive layer 100 is disposed between the cover layer 90 and the third electrode 70. In the view from the cover layer 90 to the metal shield layer 120, the second substrate 40 is disposed on the cover layer 90.

In accordance with the above description, the projective capacitive force sensing structure is able to acquire the force applied by an object and the location of the object, and the problem of the ghost point could be prevented.

The above description is merely illustrative and not restrictive. Any equivalent modification or change without departing from the spirit and scope of the present disclosure should be included in the appended claims.

What is claimed is:

1. A projective capacitive force sensing structure comprising:
a first substrate;
a first electrode disposed on the first substrate;
a first capacitance material layer disposed on the first electrode;
a second substrate disposed above the first substrate and provided with a first surface and a second surface opposite to the first surface, the first surface facing the first substrate;
a second electrode disposed on the first surface, the second electrode overlapping the first electrode, a first signal detected between the first electrode and the second electrode being collected by the first electrode; and
a third electrode disposed on the first surface or the second surface, a second signal detected between the second electrode and the third electrode being collected by the third electrode;
wherein a force applied by an object is determined according to the first signal and a location of the object is determined according to the second signal.

2. The projective capacitive force sensing structure of claim 1, wherein the first capacitance material layer is made of piezo-capacitive material, and a quantifiable electrical parameter between the first electrode and the second electrode increases when applying force to the second electrode.

3. The projective capacitive force sensing structure of claim 2, wherein the first signal is increased when the force applied to the first capacitance material layer is increased.

4. The projective capacitive force sensing structure of claim 1, wherein the value of the first signal and the value of the second signal vary in opposite directions.

5. The projective capacitive force sensing structure of claim 1, wherein the projective capacitive force sensing structure comprises a second capacitance material layer disposed on the second electrode, and an air gap located between the first capacitance material layer and the second capacitance material layer.

6. The projective capacitive force sensing structure of claim 1, wherein the second electrode connects to a first transmitting terminal, the first electrode connects to a first receiving terminal and the third electrode connects to a second receiving terminal.

7. The projective capacitive force sensing structure of claim 1, wherein the first signal is detected by mutual capacitive detection between the first electrode and the second electrode, and a capacitive interference of the second signal is blocked by the second electrode.

8. The projective capacitive force sensing structure of claim 1, wherein the second signal is detected by mutual capacitive detection between the second electrode and the third electrode and a capacitive interference of the first signal is blocked by the second electrode.

9. The projective capacitive force sensing structure of claim 1, wherein the first electrode is arranged in a first direction and the second electrode is arranged in a second direction, the first direction intersects with the second direction.

10. The projective capacitive force sensing structure of claim 9, wherein the third electrode is arranged in the first direction.

11. The projective capacitive force sensing structure of claim 1, wherein the projective capacitive force sensing structure comprises a support plate and a cover layer, the first substrate is disposed on a support plate and the second substrate is disposed on the cover layer.

12. The projective capacitive force sensing structure of claim 11, wherein the support plate comprises a shielding layer, the shielding layer is disposed opposite to the first substrate.

13. The projective capacitive force sensing structure of claim 11, wherein the projective capacitive force sensing structure comprises an adhesive layer, the adhesive layer is disposed between the support plate and the first substrate and between the cover layer and the second electrode.

14. The projective capacitive force sensing structure of claim 1, wherein the projective capacitive force sensing structure comprises a spacer, the spacer is disposed between the first substrate and the second substrate.
